(19) United States
(12) Patent Application Publication
(10) Pub. No.: US 2026/0154786 A1
(43) Pub. Date: Jun. 4, 2026

(54) METHOD AND APPARATUS FOR DETERMINING VISIBILITY

(71) Applicant: Renesas Electronics Corporation, Tokyo (JP)

(72) Inventors: Mohamed SOUBHI, Dusseldorf (DE); Jaime Andres ARANGUREN CARDONA, Dusseldorf (DE); Heinz Michael FRESE, Dusseldorf (DE)

(21) Appl. No.: 19/352,604

(22) Filed: Oct. 8, 2025

(30) Foreign Application Priority Data
Dec. 4, 2024 (DE) 10 2024 136 072.0

(51) Int. Cl. G06T 5/50; G02B 27/01; G06T 1/20; G06T 19/00; G06V 10/44; G06V 10/56

(52) U.S. Cl. CPC G06T 5/50; G02B 27/0101; G06T 1/20; G06T 19/006; G06V 10/44; G06V 10/56; G02B 2027/014; G06T 2207/20221

(57) ABSTRACT

Described herein is a method of determining visibility of predefined content in a display displaying dynamic background content. The method may comprise: after determining that the predefined content is to be overlayered on the dynamic background content for rendering in the display, obtaining at least one image representative of visual information displayed in the display; and performing a computer vision-based process based on the obtained at least one image to determine the visibility of the predefined content in the display.

### CROSS-REFERENCE TO RELATED APPLICATIONS

The disclosure of German Patent Application No. 10 2024 136 072.0 filed on Dec. 4, 2024, including the specification, drawings and abstract is incorporated herein by reference in its entirety.

### BACKGROUND

The present disclosure is generally directed to techniques related to content visibility checks, and more particularly to techniques related to determining visibility of predefined content in displays with dynamic background.

In recent years, cockpit user experience (UX) has become one of the key differentiators among car brands. Displays that are wide, panoramic, transparent, or the like are impressive features for car producers and customers. For instance, Augmented Reality (AR)-related techniques, which generally mean overlaying real images of the environment with information on the driver's navigation or infotainment display, is an increasing trend in the automotive field.

However, safety figuratively often takes a back seat while presenting visual information, even though this of course remains crucial for drivers. More precisely, displaying warning signs such as tell-tales/Advanced Driver Assistance Systems (ADAS) indicators in a transparent screen with dynamic background images is often an underestimated challenge. On such (e.g., transparent) displays, warning signs need to be displayed at times. To ensure driver safety, it must be made sure that the warning sign is actually displayed at the end of the image rendering process and that it is visible to the driver.

While in classical instrument clusters, Cyclic Redundancy Check (CRC) based schemes are typically used to recognize proper displaying of tell-tales, such approaches cannot be employed for dynamic background displays as they will frequently cause false alarms. On a static display, this is usually done by taking a CRC code of the warning image and confirming that it is correct. However, on a dynamic display, this is generally not possible since the background is dynamically changing and thus affects the CRC code.

Therefore, there exists a need for an improved mechanism, e.g., in terms of methods, apparatus, and/or systems, that can reliably and efficiently verify proper appearance or visibility of predefined content (e.g., indicators, warning signs, tell-tales, or the like) on (e.g., transparent) displays with dynamic backgrounds.

### SUMMARY

In view of some or all of the above technical needs, the present disclosure generally provides a method of determining visibility of predefined content in a display displaying dynamic background content, a corresponding apparatus, a program, and a computer-readable storage medium, having the features of the respective independent claims.

According to an aspect of the disclosure, there is provided a method of determining visibility (or appearance) of predefined (or predetermined) content in a display (e.g., a screen, a monitor, or the like) displaying dynamic background content. It may be worthwhile to note that, throughout the present disclosure, such predefined/predetermined content may be in any suitable form, such as, but certainly not limited to, warning signs, indicators, symbols, tell-tales, texts, or the like. This is not to be limited in the present disclosure. Moreover, the display may also be implemented in any suitable form, such as, but again not limited to, a display (screen) of a handheld device, a computer, a vehicle (e.g., a car), or the like.

Accordingly, the dynamic background content may comprise any suitable (background) information that is displayed (rendered) on said display. As an illustrative (non-limiting) example, in the case of the display being a car display, the background content/information may relate to for example navigation information or even infotainment information, such as music, video, or the like.

In particular, the method may comprise, after determining that the predefined content is to be overlayered on the dynamic background content for rendering in the display, obtaining at least one image representative of visual information displayed in the display. The method may further comprise performing a computer vision-based process based on the obtained at least one image to determine the visibility of the predefined content in the display (or in other words, to determine whether said predefined content is visible or not in said display). As will become apparent with the description below in more detail, any suitable computer vision related technique may be adopted here, alone or in combination, depending on various implementations and/or circumstances.

Defined as such, the present disclosure generally seeks to propose an efficient, flexible yet reliable mechanism that is capable of checking/determining proper appearance or displaying of specific (predefined) content (e.g., a warning sign) in display systems (e.g., in a vehicle) with dynamic background (even in possible cases where the display is transparent). Notably, in some possible cases, for example in the automotive industry, ensuring such content (e.g., warning signs/indicators, tell-tales, etc.) are displayed correctly and visible to drivers may be considered vital for safety, regulatory compliance, and user experience. As indicated earlier, conventional approaches (e.g., CRC based techniques) may be considered insufficient in certain use cases or scenarios, such as displays with a dynamic background where content is blended with some transparency, leading to potential safety risks and regulatory non-compliance.

In some example embodiments, the at least one image may be obtained as one or more image frames from a video stream representative of (visual) information that is to be rendered in the display. As will be understood and appreciated by the skilled person, the at least one image may be obtained in any other suitable manner, for instance, by taking a screenshot/snapshot of the display, or the like.

In some example embodiments, the video stream may be generated by blending (or overlaying) frames (e.g., image or video frames) representative of the predefined content with frames (e.g., image or video frames) representative of the dynamic background content.

In some example embodiments, a determination output (result) of visibility may comprise information indicating that: the predefined content is visible in the display, or the predefined content is not visible in the display.

In some example embodiments, if it is determined that the predefined content is not visible in the display, the method may further comprise comparing a color of the predefined content with a background color of an area (of the display) in which the predefined content is to be (or should be) rendered/displayed. In some further possible examples, if it is determined that the background color in the region of interest and the color of the predefined content are comparably similar (e.g., a red warning sign is at least partly overlapped with a red car shown in the background, thereby causing false alarms to the computer vision algorithm), it may be possible to, in some possible implementations, consider changing the color of the predefined content (e.g., from red to green) for reprocessing, in order to re-check the appearance of the predefined content in the display. Of course, as will be appreciated by the skilled person, any other suitable processing may be applied here as well. For instance, at least in theory, it may also be possible to consider (temporarily) changing the background color in said area (region of interest) in a suitable manner and repeat the whole process for determining the visibility of the predefined content.

In some example embodiments, if it is determined that the predefined content is not visible in the display, the method may further comprise generating a signal (e.g., a warning signal or the like) indicative of the predefined content being not visible in the display. The signal may be notified (e.g., visually or aurally) to at least one of: a relevant system component/entity (software or hardware), a person of interest (e.g., an end user, a driver of a vehicle, etc.), or the like. Of course, as can be understood and appreciated by the skilled person, any other suitable (safe) measure may be adopted as well, depending on various implementations and/or circumstances.

In some example embodiments, the computer vision-based process may be at least partly Artificial Intelligence (AI) based. As can be understood and appreciated by the skilled person, any suitable AI based techniques may be adopted, depending on various implementations and/or circumstances. For instance, techniques involving machine learning, Neuronal Network (NN), or the like, may be implemented. Of course, any other suitable conventional, classical methodologies may be adopted as well, even when used in combination with suitable AI based techniques.

In some example embodiments, performing the computer vision-based process may comprise generating shape features in a region of interest (ROI) within the display where the predefined content is to be (or should be) rendered/displayed. In some possible examples, the shape features may comprise, but certainly not limited to, information indicative of at least one of: contour, area, or connectivity. As can be understood and appreciated by the skilled person, generation of the shape features may involve techniques related to edge generation such as cany, sobel, hough transform, wavelets, or the like, depending on various implementations and/or circumstances.

In some example embodiments, before generating the shape features, the method may further comprise receiving an indication of the region of interest within the display where the predefined content is to be rendered, displayed, or shown. Depending on various implementations, such region of interest (or more generally, an area within the display where the predefined content ought to be rendered/displayed) may be known a-priori, such as predefined, preconfigured, or even regulated (e.g., by a standard). In some possible examples, regardless of the availability of such indication of the region of interest, the computer vision-based process may involve scanning the whole area of the display and searching for such predefined content, for generating the shape features of said predefined content.

In some example embodiments, before generating the shape features, the computer vision-based process may further comprise pre-processing the region of interest. Such pre-processing may involve at least one of: color conversion, binarization, or morphological operations. Of course, as can be understood and appreciated by the skilled person, any other suitable pre-processing techniques may be adopted as well, depending on various implementations and/or circumstances.

In some example embodiments, performing the computer vision-based process may further comprise comparing the generated shape features with those (ground truths) of the (expected) predefined content to generate one or more metrics indicative of discrepancies therebetween (i.e., between the previously generated shape features and those the expected safety content under check). Again, this may be achieved by using any suitable approach/algorithm, such as template matching, cross correlation, or the like.

In some example embodiments, performing the computer vision-based process based on the obtained at least one image to determine the visibility of the predefined content in the display may further comprise determining the visibility of the predefined content in the display based on the generated one or more metrics. In particular, such determination may involve machine learning (e.g., principal component analysis, support vector machine, etc.) and/or decision matrix-based techniques. For instance, in some possible examples, machine learning techniques may be applied to the previously generated metrics to classify those and make a decision (e.g., with the help of a decision matrix) regarding the presence or absence of the predefined content within the region of interest in the display.

In some example embodiments, the computer vision-based process may be performed repeatedly (iteratively) on a plurality of images. Accordingly, the determination of the visibility of the predefined content in the display may further involve majority voting on respective outputs of the computer vision-based process performed on the plurality of images. For instance, in some possible examples, the computer vision-based process may be repeated multiple times for the predefined content to perform the majority voting among the classifier decisions, in order to increase the confidence level of the final decision on the visibility of the predefined content.

In some example embodiments, the predefined content may be rendered in the display by using a Graphics Processing Unit (GPU), for example the GPU of the handheld device, vehicle, or the like. Of course, any other suitable (hardware) component/module may be used as well, depending on various implementations and/or circumstances.

In some example embodiments, the predefined content may comprise safety-related content, such as a warning sign, a tell-tale, or the like. Of course, any indicated earlier, any other suitable safety-related content may be possible as well, depending on various implementations and/or circumstances. For instance, in some possible examples, some other suitable graphical content like a needle of a speedometer might be considered safety critical as well, or the gear indications P, D, N, etc., speed signs, or the like. This is not to be limited in the present disclosure.

In some example embodiments, the predefined content comprises textual content (e.g., a text string, a text block, or the like). Of course, such textual content may be safety related (e.g., a safety related or warning text) as well, in some possible cases.

In some example embodiments, the display may be a vehicle display. Of course, as illustrated above, any other suitable display setup may be used as well, depending on various implementations and/or requirements.

In some example embodiments, the display may be a display with a dynamic background where content is blended with transparency. Such a display (or sometimes also simply referred to as a “transparent” display or the like in short throughout the present disclosure) may be of particular interest for techniques proposed in the present disclosure, one of the reasons being conventional (e.g., CRC based) techniques tend to cause frequent false alarms (e.g., due to a small deviation in the pixel) on such (transparent) display showing dynamic (e.g., frequently changing) background information/content.

In some example embodiments, displaying the dynamic background content may involve Augmented Reality (AR) overlaying images of the environment. For instance, such AR related techniques may involve overlaying (blending) real-time images of the environment with the information on the driver's navigation or infotainment display, or the like. Of course, as can be understood and appreciated by the skilled person, any other suitable techniques for displaying the dynamic background on the display may be implemented.

According to another aspect of the present disclosure, there is also provided an apparatus. In particular, the apparatus may comprise suitable means, e.g., a processor and a memory coupled to the processor, or the like. The processor may be adapted to cause the apparatus to carry out any of the example methods described throughout the present disclosure.

According to a further aspect of the present disclosure, a (computer) program is provided. The computer program may include instructions that, when executed by a processor, cause the processor to carry out any of the example methods described throughout the present disclosure.

According to yet another aspect of the present disclosure, a computer-readable storage medium is provided. The computer-readable storage medium may store the aforementioned computer program.

Details of the disclosed method may be implemented as systems (e.g., in the form of apparatus) adapted to execute some or all of the steps of the method, and vice versa, as the skilled person will appreciate. In particular, it is understood that methods according to the disclosure relate to methods of operating the system (or apparatus) according to the above embodiments and variations thereof and that respective statements made with regard to the systems (or apparatus) likewise apply to the corresponding methods, and vice versa.

It is also understood that in the present disclosure, the term “couple” or “coupled” refers to elements being in electrical communication with each other, whether directly connected e.g., via wires or in some other manner (e.g., indirectly). Notably, one example of being coupled is being connected.

### BRIEF DESCRIPTION OF THE DRAWINGS

Example embodiments of the disclosure are explained below with reference to the accompanying drawings, wherein like reference numbers indicate like or similar elements, and wherein

FIG. 1 schematically illustrates an example of a possible implementation of the proposed techniques according to some possible example embodiments of the present disclosure,

FIG. 2 schematically illustrates an example of a simplified implementation or working principle of the proposed techniques according to some possible example embodiments of the present disclosure,

FIG. 3 schematically illustrates an example of a possible implementation of the computer vision-based process according to some possible example embodiments of the present disclosure, and

FIG. 4 is a flowchart schematically illustrating an example of a method of determining visibility of predefined content in a display displaying dynamic background content according to some possible example embodiments of the present disclosure.

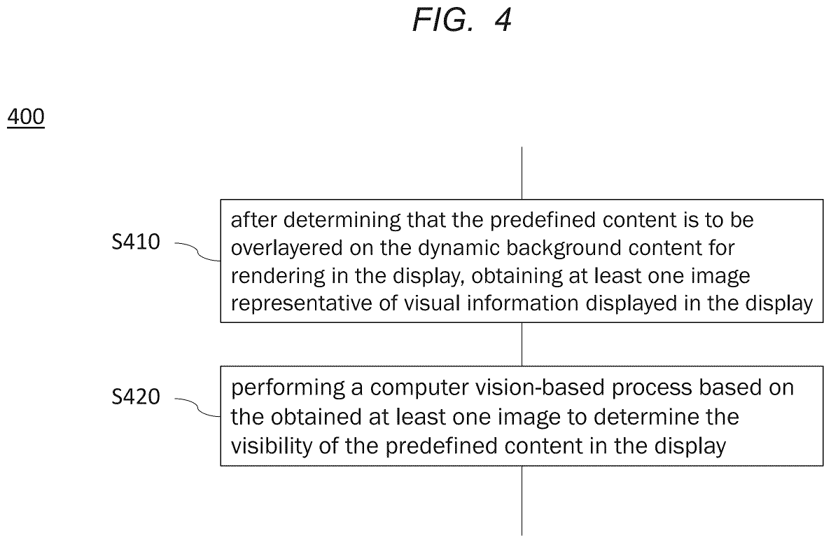

### DETAILED DESCRIPTION

As indicated above, identical or like reference numbers in the present disclosure may, unless indicated otherwise, indicate identical or like elements, such that repeated descriptions thereof may be omitted for reasons of conciseness. Moreover, it is also to be noted that the symbols used in the figures, unless indicated otherwise, are merely for illustrative purposes, and thus should not be understood to constitute a limitation of any kind.

As briefly mentioned above, in recent years, the cockpit user experience (UX) has become one of the key differentiators among car brands. Particularly, wide, panoramic, and transparent displays are captivating car manufacturers and consumers/customers alike. For instance, Augmented Reality (AR) techniques, which involve overlaying real images of the environment with information on the driver's navigation or infotainment display, is an increasing trend in automotive. On such displays, warning signs need to be presented. To ensure driver safety, it must be guaranteed that the warning sign is correctly displayed and visible to the driver.

However, safety often takes a back seat, even though presenting visual information remains crucial for drivers. More specifically, among others, displaying warning signs, tell-tales, and/or Advanced Driver Assistance Systems (ADAS) related content/information on such screens (e.g., transparent) with dynamic background images is often an underestimated challenge.

In classical instrument clusters, Cyclic Redundancy Check (CRC) based schemes are typically used to recognize the proper displaying of those signs or indicators (e.g., tell-tales). However, such approaches cannot be easily employed with dynamic background displays, as they may frequently cause false alarms (e.g., due to a small deviation in the pixel). To be more specific, on a typical static display, the verification may be usually done by taking a CRC code of the warning sign image and confirming that it is correctly visible. However, on a dynamic display, this method is not that feasible since the background is constantly changing.

Accordingly, generally speaking, in the present disclosure, a mechanism to check the proper displaying of such dynamic content (e.g., warning signs, tell-tales, etc.) even on transparent displays is proposed. In a broad sense, the present disclosure generally describes a methodology to feed back (or loop back) the image into a computer vision based (sub-)system that analyzes, through for example image recognition or the like, whether the content (e.g., warning signs, tell-tales, etc.) is properly displayed and visible. Among others, this approach may be considered beneficial to assure Functional Safety (FuSa) compliance for such dynamic display.

It may be nevertheless worth noting that, as can also be understood and appreciated by the skilled person, although the present disclosure may appear to constantly refer to warning signs, tell-tales, or the like, these are merely used as some possible examples for illustrative purposes, and thus should not be understood to constitute a limitation of any kind. As also indicated earlier, the techniques proposed in the present disclosure may be applicable for checking/determining visibility (or appearance) of any other suitable (predetermined or predefined) content within the display, which may include, but not limited to, indicators, textual information (e.g., text strings, text blocks, etc.), or the like. Similarly, although a car display may be used as an example for illustration, any other suitable display (transparent or not) of for example a handheld device, another type of vehicle, or the like may be used as well, depending on various implementations and/or circumstances.

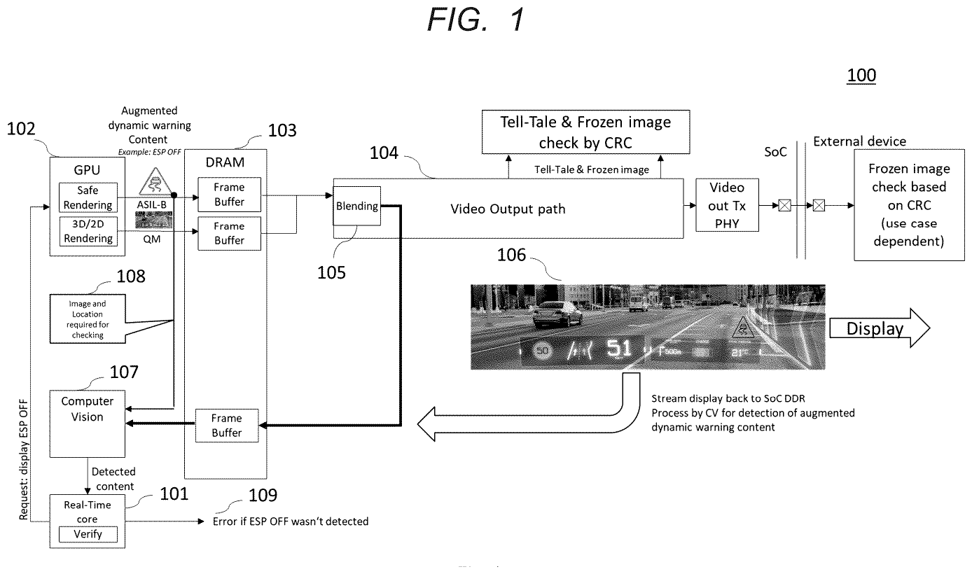

Now referring to the figures, FIG. 1 schematically illustrates an example of a possible implementation of a system 100 adopting the proposed techniques according to some possible example embodiments of the present disclosure. In this example of FIG. 1, system 100 is schematically shown for verifying the proper display of dynamic warning telltales on a transparent, AR empowered vehicle display. Generally speaking, this example system 100 may be understood to leverage computer vision techniques to ensure that the (predefined) critical warning indicators, such as “ESP OFF” in this example, are accurately displayed and visible on dynamic backgrounds, thereby meeting functional safety requirements and enhancing driver safety. As noted above, in FIG. 1, the vehicle (car) display and the warning sign “ESP OFF” are merely used as possible examples for illustrative purposes only, and thus should not be considered to constitute a limitation of any kind.

In particular, as illustratively shown in FIG. 1, the flow generally starts when a responsible module 101 (e.g., the denoted real-time core (or processor) module as exemplarily shown in FIG. 1, or any other suitable software/hardware based module/entity) in the vehicle receives a request to display (or render) a specific (predefined) warning indicator, such as “ESP OFF” (Electronic Stability Program Off) in the present case. Accordingly, this “ESP OFF” tell-tale may be understood to represent the predefined content as claimed whose visibility within the display needs to be properly verified. Depending on various implementations and/or circumstances, this request may be generated by and received from any suitable external module of the vehicle, not shown in the figures. This request then triggers the system to begin the overall verification process, so as to determine whether the requested dynamic warning sign is correctly displayed and visible on the display (showing dynamic AR-based background information). It is to be noted that, in this example of FIG. 1, this real-time core/processor module 101 may appear to be also responsible for eventually concluding the flow by verifying the visibility based on the results from the computer vision-based module 107. Of course, as can be understood and appreciated by the skilled person, this final verification/determination step may be well performed by another suitable (software/hardware based) module/entity, different from this real-time core/processor module.

Upon receiving the initial request from the real-time core/processor module 101, the GPU 102 may then be configured to initiate rendering of the augmented content. In this example of FIG. 1, the GPU includes two primary components, namely a safe rendering (ASIL (Automotive Safety Integrity Level)-B) component which may be understood to be responsible for rendering safety-critical elements (in this example, the “ESP OFF” tell-tale) with high integrity, ensuring they meet automotive safety standards; and another 3D/2D rendering (QM (Quality Management)) component which may be understood to manage general rendering tasks to create the visual content, for example including the (augmented) navigation information and possibly also other display elements. Accordingly, the output of the GPU module 102 may be seen to include both the dynamic background imagery and the warning icon, which will be properly blended (overlayed) in order to be rendered for eventual presentation to the end user (e.g., the driver or the passenger) of the vehicle.

The rendered images may be temporarily stored in the Dynamic Random Access Memory (DRAM) 103 or any other suitable storage module, which may contain a plurality of frame buffers for such image storage. This buffering would ensure smooth image processing, allowing the frames to be retrieved for blending and verification.

Further, a so-called blending process 105 or the like may be adopted to combine the augmented (overlayered) safety-related content from the GPU with the real-time, dynamic background images. This blending would ensure that the predefined content (e.g., safety-related warning telltale) could be integrated seamlessly into the panoramic AR display, providing a cohesive and non-distracting visual experience for the end user (e.g., the driver) of the vehicle.

The blended content, e.g., in terms of a video stream or the like, is then transmitted through the video output path 104, for example for other suitable (post-)processing, as well as the final rendering for displaying denoted as 106 (e.g., in the form of a sequence of image frames, a video stream, or the like), which generally represents the transparent AR display seen by the driver. Generally speaking, this display output provides an augmented reality view with critical information overlaid on the driver's real-world view, including (but not limited to) speed, navigation data, and particularly also the “ESP OFF” warning icon. Here, any suitable (conventional) (post-)processing technique may be used, depending on various implementations and/or circumstances, such that description thereof may be omitted for the sake of brevity and conciseness. For instance, as illustratively shown in the example of FIG. 1, a suitable module may be configured to check the tell-tale and/or frozen image by using (conventional) CRC techniques. Of course, depending on various implementations and/or circumstances, any suitable external device may be involved as well (e.g., coupled through the System-on-Chip (SoC)), for example for performing frozen image check based on CRC, or the like.

At the same time, the display 106 may also be properly looped back (e.g., via suitable software and/or hardware based techniques, or the like), and possibly also (temporarily) stored back in the DRAM 103, before being fed to the Computer Vision (CV) based processing module 107. The computer vision module 107 may be understood to play an important role in verifying the presence (or non-presence) and correctness of the “ESP OFF” warning indicator. In doing so, this computer vision module 107 may be configured to receive at least one image (e.g., as one or more image frames of the video stream) representative of visual information 106 displayed in the display. As will be described in more detail below, generally speaking, any suitable computer vision based techniques may be adopted, alone or in combination, including (but certainly not limited to) conventional/classical methodologies, as well as those Machine Learning (ML) or Neural Network (NN) based, or more generally, Artificial Intelligence (AI) based techniques. In some possible examples, the computer vision module 107 may also be optionally provided with reference image(s) and/or the expected location of the expected “ESP OFF” warning icon under check (denoted as 108 in FIG. 1).

As indicated above, the output of the computer vision module 107 may then be fed into the same real-time core/processor module 101 or any other suitable (software or hardware based) module for final checking/verification, in order to conclude the visibility of the predefined content (“ESP OFF”) within this dynamic display. In some possible examples, particularly if it is determined that the “ESP OFF” warning tell-tale is not correctly visible within the display, the real-time core/processor module 101 or any other suitable module may be configured to generate a signal (e.g., an error signal) 109 for indicating that the “ESP OFF” sign appears not visible in this vehicle display. For instance, a (visual or aural) indicating signal may be sent to the driver, notifying the driver in order to take any suitable measure accordingly. In some other possible examples, an indicating signal may also be sent to any suitable software/hardware module of the vehicle (or even external), for example for further troubleshooting or the like.

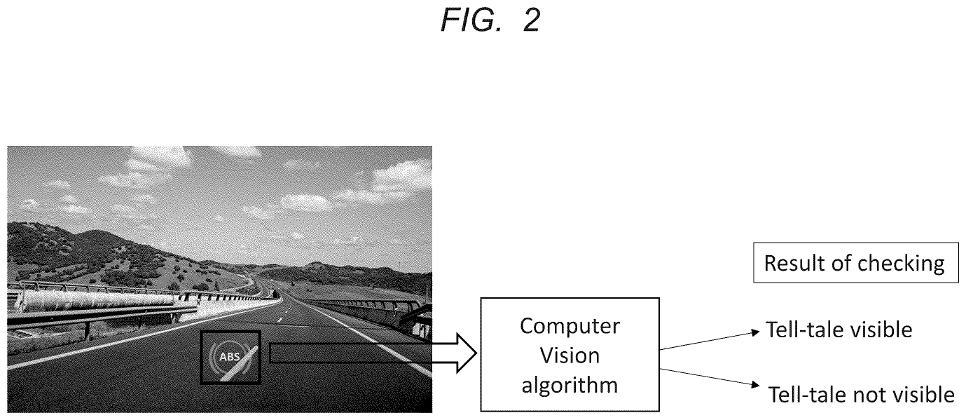

Reference is now made to FIG. 2, which schematically illustrates a simplified example implementation or working principle of the proposed techniques according to some possible example embodiments of the present disclosure.

As illustratively shown in this example of FIG. 2, in order to properly determine the visibility of a piece of predefined content (an “ABS” tell-tale in the present case) in a (vehicle) display displaying dynamic background content (in this example, again, augmented with real-time environment imagery), an image representative of the visual information currently displayed in the display is obtained. As illustrated above, this step may be triggered upon a determination (e.g., by the real-time core/processor as illustratively shown in the example of FIG. 1) that the “ABS” sign should be rendered (overlayered) in the display for notification (e.g., upon a decision to engage the ABS system of the vehicle for example due to a braking emergency). In addition, the image may be obtained for example as an image frame from the video stream representative of information that is to be rendered in the display, as illustrated above. In some other examples (for instance those not vehicle display based implementations), the image may also be possibly obtained in any other suitable manner, e.g., as simple as a screenshot/snapshot, or the like.

A suitable computer vision-based process (or algorithm) may then be applied to that image. As also illustrated above, in some possible examples, the computer vision-based process may also receive suitable information indicating the area (sometimes also referred to as the region of interest) within the display where the predefined content is supposed to be rendered, to possibly aid the computer vision-based process for better checking/determination performance. This is illustratively denoted as the square around the “ABS” sign and the arrow towards the computer vision algorithm in FIG. 2. Depending on various implementations and/or circumstances, such information on the supposed area (or region of interest) may be predetermined, preconfigured, or even regulated (e.g., in a standard, or the like). Accordingly, the display stream in the area where the content should be displayed is analyzed by the computer vision-based process. Of course, as can also be understood and appreciated by the skilled person, such area/region information is not mandatory, as, in some possible examples, the computer vision-based process may be configured to suitably scan the whole image area for determining a possible location of the expected dynamic content. For instance, in some possible examples, a suitable (e.g., classical and/or AI based) image processing algorithm may be used to dynamically determine a possible location of the content (e.g., the tell-tale) is shown. Once the location is determined, the proposed image processing as described in this disclosure may be executed.

Based on the computer vision-based process, the result of checking may be one of either that the content is visible or not visible.

In some possible examples, particularly in the case of the content being not visible, further check(s) may be conducted, such as comparing the background color with the color of the predefined content. As an illustrative example for the sake of understanding, a red warning sign (at least partly) overlayed on/overlapped with a background object with a comparably similar color (e.g., a red car), even though it may be correctly displayed/rendered in the display, may be considered (by the computer vision based process) as not properly visible. In this case, it may be an option to consider (temporarily) changing the color of the warning sign (e.g., to black or the like) for better visibility upon rendering in the display. Of course, as will be appreciated by the skilled person, any other suitable processing may be applied here as well. For instance, at least in theory, it may also be possible to consider (temporarily) changing the background color in said area (region of interest) in a suitable manner and repeat the process for (re-)determining the visibility of the predefined content. Moreover, in some possible examples, at least a warning might be initiated to the driver indicating that the content (e.g., the “ABS” tell-tale) is not visible. Of course, any other suitable (post-)process mechanisms may be invoked as well, depending on various implementations and/or circumstances. For instance, any suitable troubleshooting procedure may be engaged in case it is found that an incorrect warning sign is displayed, or even no warning sign is displayed at all. This is not to be limited in the present disclosure.

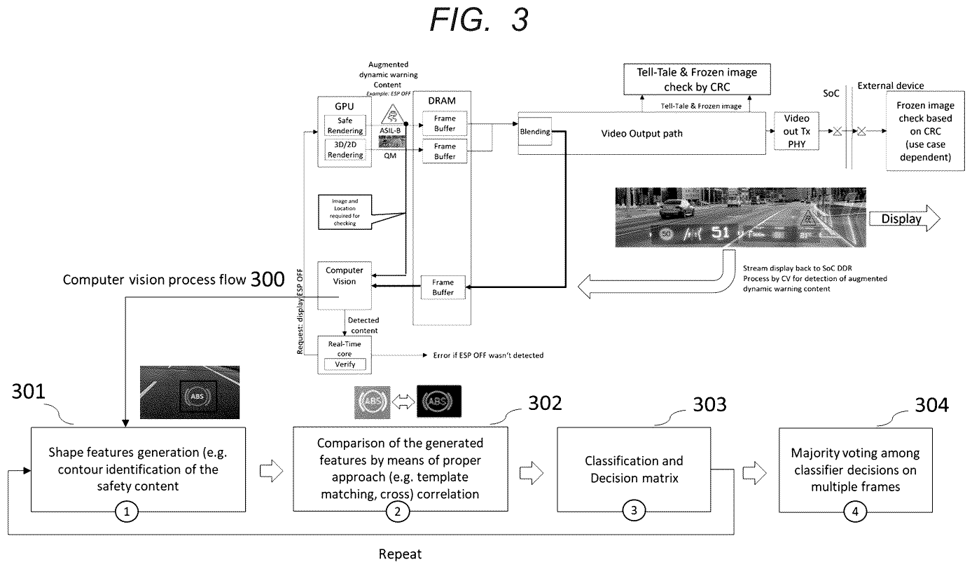

Reference is now made to FIG. 3, which illustrates in more detail an example flow 300 of a possible implementation of the computer vision-based process according to some possible example embodiments of the present. Such computer vision-based process may be applicable to the example system shown in FIG. 1 or 2. It may be worth noting that this particular example of FIG. 3 may be understood to generally represent one possibility of a classical (i.e., non-AI based) image processing algorithm based implementation. Of course, as repeatedly indicated throughout the present disclosure, any (or all) of the steps illustrated below may be replaced (or used in combination with) any suitable AI (e.g., machine learning or NN) based technique, depending on various implementations and/or circumstances.

Particularly, in the example flow 300 of FIG. 3, step 301 may involve generation of shape features (e.g., contour, area, connectivity, etc.), which may be done by any suitable methods/algorithms (e.g., edge generation such as cany, sobel, hough transform, wavelets, etc.). In some possible examples, a pre-processing of the region of interest within the display by adequate methods (e.g., color conversion, binarization, morphological operations, etc.) may be performed before the generation of the features of the dynamic safety content from the visual information currently being displayed. Generally speaking, these features may be understood to be useful for the identification presence of the safety content within the region of interest in the next step.

Next, step 302 may involve comparison of the generated features, in which the discrepancies between the features are measured and compared against those of the expected safety content under check by means of proper approach (e.g., template matching, cross correlation, or the like) and metrics of those discrepancies are generated based thereon.

Thereafter, step 303 may be invoked which involves classification and/or decision matrix-based techniques. For instance, in some possible examples, in this step, machine learning based techniques (e.g., principal component analysis, support vector machine, etc.) may be applied to the generated metrics from the previous step in order to classify those and make a decision regarding the presence or absence of the safety content within the region of interest.

As illustratively shown in the example 300 of FIG. 3, the above steps 301 to 303 may be repeated multiple times (e.g., each time based on a respective image frame from the video stream). Accordingly, majority voting 304 (or any similar technique) may be performed among the classifier decisions on those multiple frames in order to increase the confidence level of the final decision.

As noted above, the example 300 of FIG. 3 is merely shown as an illustrative example for the sake of understanding, and thus should not be understood to constitute a limitation of any kind. As can be understood and appreciated by the skilled person, any other suitable computer vision based techniques may be adopted here as well, including (but certainly not limited to) conventional/classical methodologies, as well as those Machine Learning (ML) or Neural Network (NN) based, or more generally, Artificial Intelligence (AI) based techniques, or even a combination thereof. For instance, merely as a further illustrative possible example for the sake of completeness, in some possible implementations, the computer vision based process may comprise steps including (but not limited to): applying an edge detection functionality/algorithm in an area of the display where the predefined content is to be rendered (e.g., the area of the display where the predefined content should be rendered may be preconfigured/regulated, or received as an indication); applying an extraction and reconstruction functionality/algorithm to an output of the preceding functionality/algorithm; applying a feature extraction functionality/algorithm to an output of the preceding functionality/algorithm; and finally, determining the visibility of the predefined content in the display based on an output of the preceding functionality/algorithm by using a decision matrix-based comparison. Of course, repetition of the preceding functionalities/algorithms for a plurality of frames is also possible.

Finally, a flowchart illustrating an example of a method 400 of determining visibility (or appearance) of predefined (or predetermined) content in a display (e.g., a screen, a monitor, or the like) displaying dynamic background content is schematically shown in FIG. 1. The method may be applied to any suitable system setup, which may include, but certainly not limited to, a vehicle and warning tell-tale based implementation as illustratively described above with reference to FIG. 1 or 2. For instance, as noted above, such predefined/predetermined content may be in any suitable form, such as warning signs, indicators, tell-tales, texts, or the like. Moreover, the display may also be implemented in any suitable form, such as a display (screen) of a handheld device, a computer, a vehicle, or the like. Accordingly, the dynamic background content may comprise any suitable (background) information that is displayed (rendered) on said display.

In particular, method 400 may comprise, at step S410, after determining that the predefined content is to be overlayered on the dynamic background content for rendering in the display, obtaining at least one image representative of visual information displayed in the display. Method 400 may further comprise, at step S420, performing a computer vision-based process based on the obtained at least one image to determine the visibility of the predefined content in the display (or in other words, to determine whether said predefined content is visible or not in said display).

As such, the present disclosure generally seeks to propose an efficient, flexible yet reliable mechanism that is capable of checking/determining proper appearance or displaying of specific (predefined) content (e.g., a warning sign) in display systems (e.g., in a vehicle) with dynamic background (even in possible cases where the display is transparent). Notably, in some possible cases, for example in the automotive industry, ensuring such content (e.g., warning signs/indicators, tell-tales, etc.) are displayed correctly and visible to drivers may be considered vital for safety, regulatory compliance, and user experience. As indicated earlier, conventional approaches (e.g., CRC based techniques) may be considered insufficient in certain use cases or scenarios, such as dynamic and transparent displays, leading to potential safety risks and regulatory non-compliance.

It should be noted that the apparatus/device/system features described above correspond to respective method features that may however not be explicitly described, for reasons of conciseness. The disclosure of the present disclosure is considered to extend also to such method features. In particular, the present disclosure is understood to also relate to methods of manufacturing and/or operating the apparatus/device/system described above, and/or to providing and/or arranging respective elements of these apparatus/device/system.

It is to be further noted that examples of embodiments of the disclosure are applicable to various applications or system configurations, depending on the underlying technical fields. In other words, the examples (such as the power tools) shown in the above-described figures, which are used as a basis for the above discussed examples, are only illustrative and do not limit the present disclosure in any way. That is, additional further existing and proposed new functionalities available in a corresponding operating environment may be used in connection with examples of embodiments of the present disclosure based on the principles defined.

It should also be noted that the disclosed example embodiments can be implemented in many ways using hardware and/or software configurations. For example, the disclosed embodiments may be implemented using dedicated hardware, dedicated software, and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

Finally, it should be noted that the description and drawings merely illustrate the principles of the proposed apparatus/systems and methods. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed method. Furthermore, all statements herein providing principles, aspects, and embodiments of the invention, as well as specific examples thereof, are intended to encompass equivalents thereof.

What is claimed is:

1. A method of determining visibility of predefined content in a display displaying dynamic background content, the method comprising:
after determining that the predefined content is to be overlayered on the dynamic background content for rendering in the display,
obtaining at least one image representative of visual information displayed in the display; and
performing a computer vision-based process based on the obtained at least one image to determine the visibility of the predefined content in the display.

2. The method according to claim 1, wherein the at least one image is obtained as one or more image frames from a video stream representative of information that is to be rendered in the display.

3. The method according to claim 2, wherein the video stream is generated by blending frames representative of the predefined content with frames representative of the dynamic background content.

4. The method according to claim 1, wherein a determination output of visibility comprises information indicating that: the predefined content is visible in the display, or the predefined content is not visible in the display.

5. The method according to claim 1, wherein, if it is determined that the predefined content is not visible in the display, the method further comprises:
comparing a color of the predefined content with a background color of an area of the display in which the predefined content is to be rendered.

6. The method according to claim 1, wherein, if it is determined that the predefined content is not visible in the display, the method further comprises:
generating a signal indicative of the predefined content being not visible in the display.

7. The method according to claim 1, wherein the computer vision-based process is artificial intelligence, AI, based.

8. The method according to claim 1, wherein performing the computer vision-based process comprises:
generating shape features in a region of interest within the display where the predefined content is to be rendered, wherein the shape features comprise information indicative of at least one of: contour, area, or connectivity.

9. The method according to claim 8, wherein before generating the shape features, the method further comprises:
receiving an indication of the region of interest within the display where the predefined content is to be rendered.

10. The method according to claim 8, wherein before generating the shape features, the computer vision-based process further comprises:
pre-processing the region of interest, which involves at least one of: color conversion, binarization, or morphological operations.

11. The method according to claim 8, wherein performing the computer vision-based process further comprises:
comparing the generated shape features with those of the predefined content to generate one or more metrics indicative of discrepancies therebetween.

12. The method according to claim 11, wherein performing the computer vision-based process based on the obtained at least one image to determine the visibility of the predefined content in the display further comprises:
determining the visibility of the predefined content in the display based on the generated one or more metrics, which involves machine learning and/or decision matrix-based techniques.

13. The method according to claim 1, wherein the computer vision-based process is performed repeatedly on a plurality of images; and
the determination of the visibility of the predefined content in the display further involves majority voting on respective outputs of the computer vision-based process performed on the plurality of images.

14. The method according to claim 1, wherein the predefined content is to be rendered in the display by using a graphics processing unit, GPU.

15. The method according to claim 1, wherein the predefined content comprises safety-related content.

16. The method according to claim 1, wherein the predefined content comprises textual content.

17. The method according to claim 1, wherein the display is a vehicle display.

18. The method according to claim 1, wherein the display is a display with a dynamic background where content is blended with transparency.

19. The method according to claim 1, wherein displaying the dynamic background content involves augmented reality overlaying images of the environment.

20. An apparatus, comprising a processor and a memory coupled to the processor, wherein the processor is adapted to cause the apparatus to carry out the method according to claim 1.
